(19) United States
(12) Patent Application Publication
(10) Pub. No.: US 2003/0221105 A1
(43) Pub. Date: Nov. 27, 2003

(54) Extensible mechanism for attaching digital signatures to different file types

(75) Inventor: Samir Bajaj, Novato, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 10/151,621

(22) Filed: May 20, 2002

(51) Int. Cl. H04L 9/00

(52) U.S. Cl. 713/176; 713/175

(57) ABSTRACT

A Digital Signature Extension provides a secure environment where digital signatures associated with the electronic documents can be verified. The Digital Signature Extension comprises: (1) cryptographic services for performing cryptographic operations on the digital signatures associated with the electronic documents, (2) one or more file-specific components for authenticating the digital signatures associated with the electronic documents, wherein the electronic documents are stored in a particular file format, and for interfacing to the cryptographic services, so that the cryptographic operations can be performed on the digital signatures, and (3) one or more applications for implementing logic for accessing the documents and for interfacing to the file-specific components, so that the file-specific components can authenticate the digital signatures.

### BACKGROUND OF THE INVENTION

1. Field of the Invention.

The present invention relates generally to an extensible mechanism for attaching digital signatures to different file types.

2. Description of the Related Art.

In today's highly collaborative environment, sharing documents over the Internet is often a requirement for most businesses. However, transmitting documents over the Internet, and sharing those documents with others, can be risky. Someone could unintentionally, or even intentionally, alter the data contained therein.

Thus, it is important to ensure that, when documents are transmitted electronically, the contents are secured against alteration. Digital signatures are useful for verifying that a document was authored by a certain person, and that it was not altered or modified by anyone else. The process of verifying the integrity of a document is known as validating the authenticity of the documents.

One type of digital signature technology is based on public-key cryptography, a widely accepted technology standard. Public-key cryptography uses a matched pair of encryption and decryption keys, i.e., a Public Key and a Private Key. Each key performs a one-way transformation upon the document. Each key is the inverse function of the other; what one does, only the other can undo. The Public Key is made publicly available by its owner, while the Private Key is kept secret. To send a private document, a sender encrypts the document with the intended recipient's Public Key. The document can then only be decoded with the recipient's Private Key.

Inversely, senders can also encrypt documents using their Private Key; in other words, keys work in either direction. This provides the basis for the “digital signature,” for if one person can decrypt a document with someone's Public Key, that other person must have used his or her Private Key to encrypt it in the first place. Since only key owners can utilize their own Private Keys, the encrypted document becomes a kind of electronic signature, i.e., a document that nobody else can produce.

For authentication purposes, the plain text of a document is usually processed by a hashing algorithm, in order to create a digest, which is then encrypted using the sender's Private Key and included in the sender's digital signature. The result can only be decrypted by the sender's Public Key. The recipient decrypts the document and then recalculates the digest. The value of this newly calculated digest is compared to the value of the digest found from the digital signature. If the two match, the document has not been tampered with.

To ensure the trustworthiness of the key pairs, a digital certificate is normally used. A digital certificate, also known as a digital ID, includes the user's Public Key, and can include other information, such as name and address, and is “digitally signed” by someone trusted to do so, typically called a Certificate Authority. Commercial Certificate Authorities include Verisign Inc. and British Telecommunications.

The recipient of a document first uses the digital certificate to verify with the Certificate Authority that the sender's Public Key is authentic, and then uses that Public Key to verify the document itself. This way, only one Public Key, that of the Certificate Authority, has to be centrally stored or widely publicized, since then everyone else can simply transmit their Public Key and valid digital certificate with their documents.

Consequently, digital signatures are useful for anyone who shares documents electronically with others. Digital signatures reduce the risk to the sender of a document, because any modification to the document after it has been sent out invalidates the sender's signature. Digital signatures assure the recipient of the identity of the signer and provide nonrepudiation, so the signer cannot disown the document, claiming never to have signed it.

What is needed, however, is an extensible mechanism for using digital signatures. Specifically, there is a need in the art for mechanisms that simplify the use of digital signatures by various types of applications.

### SUMMARY OF THE INVENTION

The present invention provides a method, apparatus, and article of manufacture for securing electronic documents. A Digital Signature Extension, executed by a computer, provides a secure environment where digital signatures associated with the electronic documents can be verified. The Digital Signature Extension comprises:

(1) cryptographic services for performing cryptographic operations on the digital signatures associated with the electronic documents;

(2) one or more file-specific components for authenticating the digital signatures associated with the electronic documents, wherein the electronic documents are stored in a particular file format, and for interfacing to the cryptographic services, so that the cryptographic operations can be performed on the digital signatures; and

(3) one or more applications for implementing logic for accessing the documents and for interfacing to the file-specific components, so that the file-specific components can authenticate the digital signatures.

The file-specific component is a “plug-in” registered with the Digital Signature Extension as providing support for the electronic documents stored in the particular file format. The Digital Signature Extension includes runtime discovery by the application of which file-specific component provides support for the electronic documents stored in the particular file format.

The file-specific components include means for determining which portions of the particular file format are used to compute the digital signature. The file-specific components also include means for determining a location within the particular file format where the digital signature is stored.

The file-specific components include application programming interfaces that include one or more methods selected from a group of methods comprising: a method that determines if the electronic document is signed with the digital signature; a method that signs the electronic document with the digital signature; a method that validates the digital signature on the electronic document; and a method that extracts the digital signature from the electronic document.

The core cryptographic services include application programming interfaces that include one or more methods selected from a group of methods comprising: a method that enumerates one or more digital certificates; a method that verifies the digital certificate; a method that computes the digital signature using the digital certificate; a method that verifies the digital signature; and a method that extracts data from the digital signature.

A data structure is used to transport digital certificate-related and digital signature-related information between the file-specific components and the core cryptographic services.

### BRIEF DESCRIPTION OF THE DRAWINGS

Referring now to the drawings in which like reference numbers represent corresponding parts throughout:

FIG. 1 schematically illustrates a hardware and software environment in accordance with a preferred embodiment of the present invention; and

FIG. 2 is a block diagram that illustrates the architecture of a Digital Signature Extension according to a preferred embodiment of the present invention;

FIG. 3 shows an exemplary dialog box used for displaying the information associated with digital certificate, which can be obtained from a commercial Certificate Authority;

FIG. 4 shows an exemplary dialog box used for attaching digital certificates to documents;

FIG. 5 shows an exemplary icon overlay for files having digital signatures attached, wherein the icon overlay indicates which files have valid digital signatures attached;

FIG. 6 shows an exemplary Properties page for the file indicating that the digital signature is invalid;

FIG. 7 shows an exemplary Properties page for the file indicating that the digital signature is invalid;

FIG. 8 shows an exemplary dialog box for validating the digital signatures; and

FIGS. 9 and 10 are flowcharts that illustrate the logic of the client software 108 according to the preferred embodiment of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

1 Overview

The present invention uses digital signatures in a document-sharing environment in a manner that accommodates disparate types of file formats without having to re-deploy or upgrade the existing installation in any way. This provides for extensibility by isolating details specific to a particular file format from the digital signatures technology and the associated applications that operate on different types of file formats.

Software developers can therefore leverage this environment by extending or adapting it for new types of file formats specific to their applications. In particular, the present invention allows developers to make use of low-level facilities, including the basic cryptographic operations of computing and verifying digital signatures, with much ease and with a minimal investment of time and effort.

2 Hardware Environment

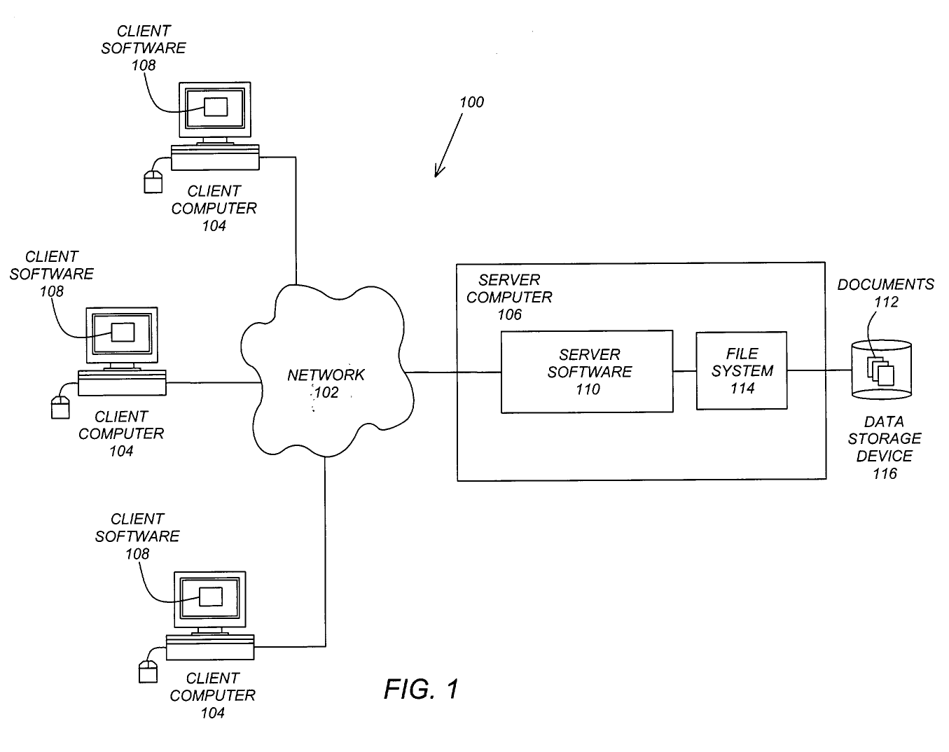

FIG. 1 schematically illustrates a hardware and software environment in accordance with a preferred embodiment of the present invention, and more particularly, illustrates a typical distributed computer system 100 using a network 102 to connect client computers 104 to server computers 106. A typical combination of resources may include a network 102 comprising the Internet, an Intranet, local area networks (LANs), or the like, client computers 104 that are personal computers or workstations, and server computers 106 that are personal computers, workstations, minicomputers, or mainframes.

The client computers 104 may execute client software 108 and communicate with server computers 106 executing server software 110. In the preferred embodiment, the client software 108 on various client computers 104 share electronic documents 112 as in a manner mediated by the server software 110. The server software 110 is configured to respond to requests by the client software 108 for documents 112. The server software 110 may also be configured to control access to documents 112 by the client software 108. Additionally, the server software 110 may manage the documents 112 using a file system 114 that stores the documents 112 on a data storage device 116, wherein the documents 112 may be stored in any number of different file formats. However, those skilled in the art will recognize that the present invention may be used in any environment and with any application.

Generally, these components 108-114 all comprise logic and/or data that is embodied in or retrievable from a device, medium, signal, or carrier, e.g., a data storage device, a data communications device, a remote computer or device coupled to the computer via a network or via another data communications device, etc. Moreover, the logic and/or data, when read, executed, and/or interpreted, results in the steps for implementing and/or using the present invention being performed.

Thus, embodiments of the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

3 Digital Signature Extension

When documents 112 are transmitted electronically across the Internet, users can ensure that the documents 112 are secured with a Digital Signature Extension according to the preferred embodiment of the present invention. The Digital Signature Extension provides a solution for digitally signing and authenticating documents 112.

The Digital Signature Extension, which comprises at least part of the client software 108 and is executed by the client computer 104, provides a secure environment where digital signatures associated with the documents 112 can be verified for:

Identity (confirming identity of the persons who sign the documents 112),

Data Integrity (the documents 112 have not been changed), and

Nonrepudiation (signers cannot claim they never signed documents).

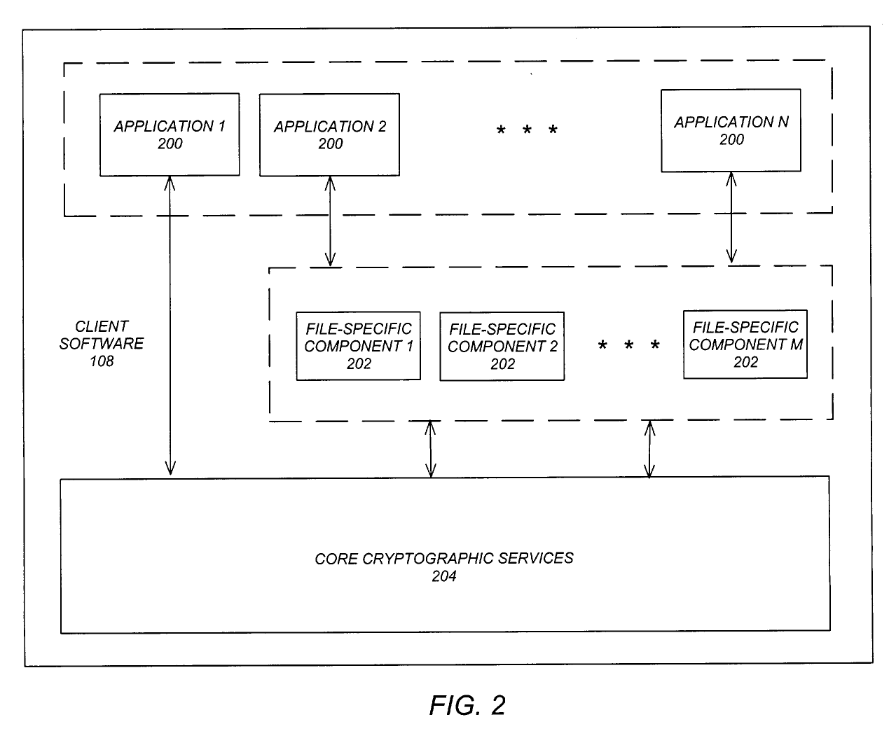

FIG. 2 is a block diagram that illustrates the architecture of the Digital Signature Extension according to a preferred embodiment of the present invention. Generally, this architecture comprises three layers of functionality in the context of the client software 108, including one or more applications 200, one or more file-specific components 202, and a set of core cryptographic services 204.

The applications 200 are the topmost layer in the architecture. One or more applications 200 are present and comprise any software used for implementing logic for accessing, creating editing and/or viewing the documents 112 (which may contain text, graphics, images or other digital data), and for interfacing to the file-specific components 202, so that the file-specific components 202 can authenticate the digital signatures associated with the documents 112. Consequently, the applications 200 are the main users of the services and functionality in the Digital Signature Extension.

The file-specific components 202 comprise a layer that is sandwiched between the applications 200 and the core cryptographic services 204. One or more file-specific components 202 are used for authenticating the digital signatures associated with the documents 112, wherein the documents 112 are stored in a particular file format, and for interfacing to the core cryptographic services 204, so that the cryptographic operations can be performed on the digital signatures. For most part, applications 200 invoke methods exposed by the file-specific components 202 in the middle layer, although applications 200 may also invoke methods exposed by the core cryptographic services 204 in the lower layer.

The core cryptographic services 204 are used for performing cryptographic operations on the digital signatures associated with the documents 112. These operations include certificate management and enumeration, signature computation and verification, etc. The core cryptographic services 204 provides a valuable level of abstraction to the layers above it, and offers them the luxury of not having to deal with low-level manipulation of cryptographic information.

The architecture has been designed with extensibility in mind. Specifically, the layered approach of the architecture means that each layer provides services to the one above it. Customization is facilitated at the top layer, in the applications 200, which allows developers to write additional applications 200, and in the middle layer, in the file-specific components 202, where support for additional types of file formats can be added. The core cryptographic services 204 can thus be extended to work with any type of file format.

Following is a description of the data structures and methods associated with this architecture.

4 Data Structures

The Digital Signature Extension includes a “SignParams” data structure that is used to transport digital certificate-related and digital signature-related information between the file-specific components 202 and the core cryptographic services 204. Doing so reduces the number of parameters passed to the various methods:

typedef struct SignParams
{

| | |
|---|---|
| long cbSize; | // length in bytes of SignParams |
| BSTR bstrCertSubject; | // Name of the signer |
| BSTR bstrCertIssuer; | // Certificate Authority name |
| BSTR bstrCertSerialNumber; | // Certificate serial number |
| BSTR bstrCertSubjectEMail; | // Email address of the signer |
| BSTR bstrCertX500; | // X.500 name of signer |
| BSTR bstrComment; | // Comments |
| BSTR bstrTimestamp; | // Timestamp |
| VARIANT* pvReserved; | // reserved for future use |

} SignParams, *pSignParams;

The parameter pvReserved of type VARIANT* is a “hook” to allow an application 200 to pass additional context-specific or file-specific information to one or more file-specific components 202 in the middle layer. The objective of having this argument is to promote the development of additional applications 200 and file-specific components 202 that could benefit from information passed via this argument, and have those new applications 200 and file-specific components 202 interoperate with the existing architecture.

5 Registration

The Digital Signature Extension includes runtime discovery by the application 200 of which file-specific component 202 provides support for electronic documents 112 stored in a particular file format. The file-specific component 202 comprises a “plug-in” that is registered with the Digital Signature Extension as providing support for the electronic documents 112 stored in the particular file format. Typically, such a file-specific 202 component would include means for determining which portions of the particular file format are used to compute the digital signature, as well as means for determining a location within the particular file format where the digital signature is stored. Doing so isolates file format-specific information to one component 202 in the middle layer, and further enhances extensibility by leaving the door open to the possibility of replacing it at any time down the road.

Once such a component 202 has been written, it is registered using a Register method in the IAdskFindSignFile interface:

interface IAdskFindSignFile : IUnknown
{

HRESULT Register(

| | |
|---|---|
| [in] BSTR bstrExt, | // File extension |
| [in] const CLSID* pClsid | // Class ID of associated |
| | component |
| ); | |

HRESULT Lookup(

| | |
|---|---|
| [in] BSTR bstrExt, | // File extension |
| [out] CLSID* pClsid | // Class ID of associated |
| | component |
| ); | |

/ / other methods not shown

};

Applications 200 will typically invoke the Lookup method to determine the CLSID (class ID) of the component 202 that implements a specific type of file format, and then call the appropriate methods of that component 202.

6 File-Specific Component Application Programming Interfaces

Generally, the file-specific components 202 include application programming interfaces that include one or more methods selected from a group of methods comprising: a method that determines if the electronic document 112 is signed with the digital signature; a method that signs the electronic document 112 with the digital signature; a method that validates the digital signature on the electronic document 112; and a method that extracts the digital signature from the electronic document 112. These methods are designed to be granular, in that each of them is designed to perform only one specific task. Applications 200 can combine calls to these methods in accordance with their requirements.

Specifically, a file-specific component 202 is required to implement the interfaces IAdskSignFile and IAdskGetData, described in the following sections.

6.1 IAdskSignFile

The IAdskSignFile interface provides the methods that an application 200 can use directly. They are also intuitive and easy to call, and are designed to map to the most common use cases.

6.1.1 IsFileSigned

The IsFileSigned method simply determines if the file specified via the bstrPath parameter is signed, but it does not actually attempt to validate the signature. The presence of the signature is denoted by a TRUE value in the *bResult parameter (a FALSE value indicates that a signature is not present).

HRESULT IsFileSigned(

[in] BSTR bstrPath,
[in] VARIANT* pvReserved,
[out] BOOL* bResult
);

6.1.2 AddSign

The AddSign method inspects the incoming parameters to make sure that they are valid, packages them into a form suitable for consumption by a corresponding method in the core services interface and then invokes that method.

HRESULT AddSign(

[in] BSTR bstrPath
[in] BSTR bstrCertSubject,
[in] BSTR bstrCertIssuer,
[in] BSTR bstrCertSerialNumber,
[in] BSTR bstrComment,
[in] BSTR bstrTimeServer,
[in] IAdskSystemTime* pTimestamp,
[in] VARIANT* pvReserved

);

The implementation of this method eventually calls the ComputeSignature method of the IAdskSignature interface implemented as part of the core cryptographic services 204 that constitute the lowest layer in this architecture, which is where all cryptographic operations are performed.

6.1.3 VerifySign

The VerifySign method attempts to validate the signature on the file specified via bstrPath. If the signature is valid, *bResult is set to TRUE; otherwise, it is set to FALSE. If the file is not signed, the method returns S_FALSE. Applications 200 using this method should insert a check for a return value of S_FALSE before assuming that the signature is valid. Invoking this method is the definitive way to check the validity of a signature.

HRESULT VerifySign(

[in] BSTR bstrPath,
[in] VARIANT* pvReserved,
[out] BOOL* bResult

);

The implementation of this method eventually calls the VerifySignature method of the IAdskSignature interface implemented as part of the core cryptographic services 204 that constitute the lowest layer in this architecture; which is where all cryptographic operations are performed.

6.1.4 ExtractSignatureInfo

As its name suggests, the ExtractSignatureInfo method reads the signature information associated with the file specified via bstrPath and returns data of interest in a format fit for consumption by users. This includes the name of the signer, e-mail address (if available), name of the authority that issued the certificate, the timestamp, etc. The parameter *pbstrCertX500String contains the stringized X.500 name of the signer. The parameters *ppCertNotBefore and *ppCertExpiration define the time window in which the signer's certificate is valid.

Note that this method does not attempt to verify the signature; in other words, it may be possible that this method “succeeds” despite the fact that the signature is invalid.

HRESULT ExtractSignatureInfo(

[in] BSTR bstrPath,
[in] VARIANT* pvReserved,
[out] BSTR* pbstrCertSubject,
[out] BSTR* pbstrCertIssuer,
[out] BSTR* pbstrCertSubjectEMail,
[out] BSTR* pbstrCertSerialNum,
[out] BSTR* pbstrCertX500String,
[out] BSTR* pbstrComment,
[out] IAdskSystemTime** ppCertNotBefore,
[out] IAdskSystemTime** ppCertExpiration,
[out] BSTR* pbstrTimeServer,
[out] IAdskSystemTime** ppTimestamp

);

The implementation of this method eventually calls the ExtractSignatureInfo method of the IAdskSignature interface implemented as part of the core cryptographic services 204.

6.2 IAdskGetData

The IAdskGetData interface contains only one method, GetNextDataBlock.

6.2.1 GetNextDataBlock

The methods in the interface IAdskSignFile should be able to operate on a file of any given length. In order to accommodate content of all sizes, the file-specific component 202 implements the IAdskGetData interface and passes it to the core cryptographic services 204, that, in turn, will call back (repeatedly, if necessary) to retrieve the data for which a signature needs to be computed or verified. On each call, the implementation will set the outgoing parameter *bMore to TRUE if additional data can be retrieved, until all the data has been exhausted, at which time the parameter will be set to FALSE.

HRESULT GetNextDataBlock(

[in, out] long* pElems,
[out, size_is(*pElems)] BYTE** rgbData,
[out] BOOL* bMore

);

7 Core Cryptographic Services Application Programming Interfaces

Generally, the core cryptographic services 204 include application programming interfaces that include one or more methods selected from a group of methods comprising: a method that enumerates one or more digital certificates; a method that verifies the digital certificate; a method that computes the digital signature using the digital certificate; a method that verifies the digital signature; and a method that extracts data from the digital signature. Specifically, these methods provide the cryptographic operations that perform the real work of digital signature generation and verification, certificate management, etc.

7.1 IAdskSignature

Methods in the IAdskSignature interface offer basic, client-agnostic services to the file-specific components 202 in the middle layer, as well as to the applications 200 in the top layer. This is accomplished by exchanging information in a neutral format, such as unsigned chars that can represent data pulled from any source (file or non-file type).

7.1.1 EnumerateCertificates

The EnumerateCertificates method returns counted arrays of the attributes of all certificates installed in the user's local certificate store. Note, however, that certificates without associated private keys are not included, so in a sense the list is filtered to exclude those certificates that cannot be used to sign a file. The parameter *pElems indicates the size of the arrays rgSubject (name of the certificate subject), rgIssuer (name of the issuing authority), rgSerialNumber (certificate serial number), and rgExpiration (certificate expiration).

HRESULT EnumerateCertificates(

[in, out] long* pElems,
[out, size_is(*pElems)] BSTR** rgSubject,
[out, size_is(*pElems)] BSTR** rgIssuer,
[out, size_is(*pElems)] BSTR** rgSerialNumber,
[out, size_is(*pElems)]
IAdskSystemTime*** rgExpiration

);

The caller should access elements of the attribute arrays only if *pElems is non-zero and positive.

7.1.2 VerifyCertificate

The VerifyCertificate method attempts to locate a certificate with the specified subject, issuer, and serial number, and then validates the chain for integrity and correctness. Specifically, it checks to see that the signature on the certificate is intact, and that the certificate chain leads to a trusted root installed on the user's system. This method is to be used to verify a local user's certificates only; callers should not attempt to validate certificates received from other people using this method.

HRESULT VerifyCertificate(

[in] BSTR bstrSubject,
[in] BSTR bstrIssuer,
[in] BSTR bstrSerialNumber,
[out] BOOL* bResult,
[out] long* plStatus

);

7.1.3 ComputeSignature

The ComputeSignature method takes the certificate-related information specified in the *pSignParams structure and uses it to locate the certificate that will be utilized in computing the digital signature. The data to be signed is pulled from the caller via repeated invocation of the callback method IAdskGetData::GetNextDataBlock. If the operation is successful, the resulting signature data is returned in the rgbSignData argument, with *pElemsSign containing its length.

HRESULT ComputeSignature(

[in] PSIGNPARAMS pSignParams,
[in] IAdskGetData* pGetFileData,
[in, out] long* pElemsSign,
[out, size_is(*pElemsSign)] BYTE** rgbSignData

);

7.1.4 VerifySignature

The VerifySignature method is the only definitive, fail-safe way to validate a digital signature. It accepts as arguments a pointer to the callback interface IAdskGetData that the core cryptographic services 204 in the lower layer will use to retrieve the contents claimed to have been signed, as well as the signature information itself in rgbSignData and cElemsSign. It then performs the required cryptographic operations to determine not only whether the signature is valid, but also whether the certificate used to compute the signature can be verified (i.e., has not been altered). The parameter *bResult is set to TRUE only if the method succeeds in verifying the signature.

HRESULT VerifySignature(

[in] IAdskGetData* pGetFileData,
[in] long cElemsSign,
[in, size_is(cElemsSign)] BYTE* rgbSignData,
[out] BOOL* bResult

);

7.1.5 GetRFC868Time

The GetRFC868Time method takes as argument the name or IP address (in string format) of a server computer 106 that responds to requests for UTC (Coordinated Universal Time) in RFC-868 format, and returns the information via the IAdskSystemTime interface. If NULL is specified for the bstrTimeServer argument, the client computer 104 is queried for the system time. Time information is always returned in UTC. A timeout value (in milliseconds) can be specified via the lTimeoutMilliSec parameter; to use the default timeout, this argument is set to zero.

HRESULT GetRFC868Time(

[in] BSTR bstrTimeServer,
[in] long 1TimeoutMilliSec,
[out] IAdskSystemTime** ppST

);

7.1.6 ExtractSignatureInfo

The ExtractSignatureInfo method attempts to parse the cryptographic data supplied in rgbSignData and cElemsSign and pull out information of interest, including the subject (signer) and issuer name on the certificate used to generate the signature, the certificate's expiration date, as well as the timestamp associated with the signature. If the signer had specified comments to be included in the signature, that information is also returned. This information is returned via the [out] parameters pSignParams and ppCertExpiration. Note that this method does not attempt to verify the signature.

HRESULT ExtractSignatureInfo(

[in] long cElemsSign,
[in, size_is(cElemsSign)] BYTE* rgSignData,
[out] PSIGNPARAMS pSignParams,
[out] IAdskSystemTime** ppCertNotBefore,
[out] IAdskSystemTime** ppCertExpiration

);

7.1.7 IAdskSystemTime

The IAdskSystemTime interface delivers date and time information as a set of read-only properties via appropriately-named accessor methods. These methods are self-documenting.

interface IAdskSystemTime : IDispatch{

HRESULT get_Year([out, retval] short* pVal);
HRESULT get_Month([out, retval] short* pVal);
HRESULT get_Day([out, retval] short* pVal);
HRESULT get_Hour([out, retval] short* pVal);
HRESULT get_Minutes([out, retval] short* pVal);
HRESULT get_Seconds([out, retval] short* pVal);

};

8 Creating a New File-Specific Component

Each of the file-specific components 202 encapsulates logic to deal with details specific to one or more file formats. Each file-specific component 202 is required to implement the IAdskSignFile and IAdskGetData interfaces described above. However, the file-specific component 202 need not concern itself with the cryptographic operations. Instead, a typical implementation of the file-specific component 202 would simply read the specific data from the file that needs to be digitally signed, and pass it on to the methods implemented by the core cryptographic services 204.

9 Applications

From the perspective of an application 200, all middle-layer file-specific components 202 are identical, in that they present a uniform interface. Each file-specific component 202 supports identical functionality, that of signing files, verifying signatures, etc.

An application 200 identifies which file-specific component 202 to invoke by means of the Lookup method:

interface IAdskFindSignFile : IUnknown
{

HRESULT Lookup(

[in] BSTR bstrExt,
[out] CLSID* pClsid

);

// other methods not shown

};

Note that this method takes a BSTR (binary string) and returns a CLSID (class ID). The BSTR parameter identifies a specific file extension (e.g., *.doc, *.dwg, *.gif, etc.) and a CLSID parameter is returned that corresponds to the file-specific component 202 that encapsulates details related to files having that specific file extension. Typically, such a file-specific component 202 would know how to parse the file and where the signature is to be stored. As a consequence of such a design, the application 200 does not need to be modified after it has been deployed.

Using the architecture described above, an application 200 may provide a number of user interface features, including the features described in the table below:

| Feature | Function | Benefit |
|---|---|---|
| Select Digital ID | Allows users to | Use different digital IDs in |
| | choose from | different circumstances. For |
| | different digital | instance, a contractor working |
| | certificates. | for two companies can use |
| | | different IDs on each project. |
| Attach Digital | Attaches digital | Simple and intuitive interface |
| Signature | signatures to | for attaching digital signatures. |
| | single or sets of | Sign large numbers of files in a |
| | files. | single operation. |
| Time Stamp | Includes optional | Document exactly when files |
| | time stamp with | are signed. Allows recipient to |
| | signature | easily identify most recent copy. |
| Validate Signature | Validates digital | Easily validate multiple |
| | signature in | signatures on documents. |
| | current document. | |

In any application 200, there are two tasks associated with digital signatures: applying a digital signature and validating a digital signature.

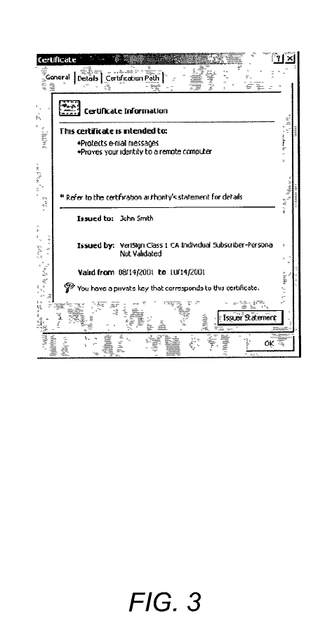

The first step in using digital signatures is obtaining a digital ID. FIG. 3 shows an exemplary dialog box used for displaying the information associated with digital certificate, which can be obtained from a commercial Certificate Authority.

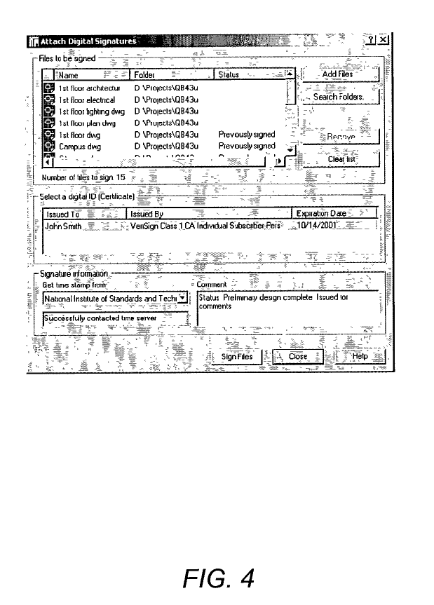

The user can attach a digital signature to any file that is compatible with the Digital Signature Extension, i.e., that has a corresponding file-specific component 202. FIG. 4 shows an exemplary dialog box used for attaching digital signatures. The Digital Signature Extension allows users to sign multiple files in a single session.

If the user has multiple digital IDs on their computer (e.g., a personal ID and a business or professional ID, for instance), they can select which digital ID to apply to the document.

The user can include a time stamp with their signature, which indicates the time at which the signature was applied, and explanatory comments. For reasons of efficiency, comments are limited to about 4000 Unicode characters (wide character type), which accommodate any language supported by the operating system.

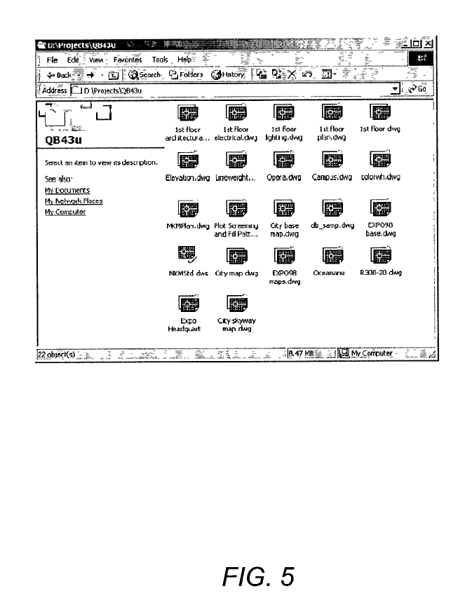

The second step in using digital signatures is validating the digital signature. Digital signatures can be validated either from the Microsoft® Windows® Explorer or from the application 200. FIG. 5 shows an exemplary icon overlay for files having digital signatures attached, wherein the icon overlay indicates which files have valid digital signatures attached.

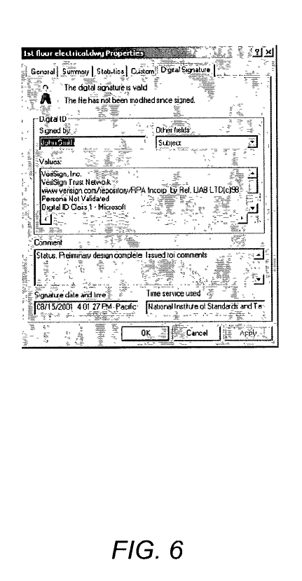

Right-clicking on the file brings up the Properties page for that file, where the user can validate the identity of the signer, and view the time stamp and comments attached to the signature. FIG. 6 shows an exemplary Properties page for the file indicating that the digital signature is invalid.

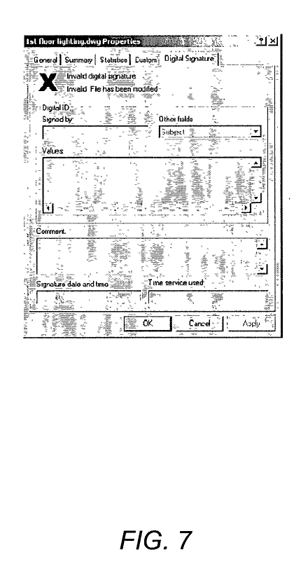

If the file has been tampered with in any way, the digital signature is invalid. FIG. 7 shows an exemplary Properties page for the file indicating that the digital signature is invalid.

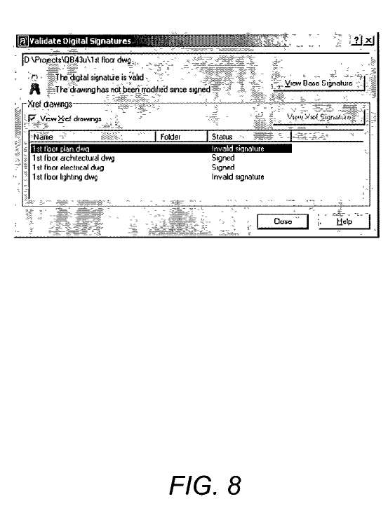

Validating digital signatures from within the application 200 displays the status of the digital signature for the documents. FIG. 8 shows an exemplary dialog box for validating the digital signatures.

10 Digital Signature Verifier

One application 200 that has been created by the assignee of the present invention comprises a Digital Signature Verifier, which may be used in conjunction with other client software 108 that does not incorporate the Digital Signature Extension. The Digital Signature Verifier is an independent application 200 that lets recipients who do not have client software 108 incorporating the Digital Signature Extension verify a digital signature. It also warns the recipient that any unauthorized file changes will invalidate the digital signature. The Digital Signature Verifier is so compact, it can be sent to others as an e-mail attachment or downloaded from a web site!

11 Logic of the Preferred Embodiment

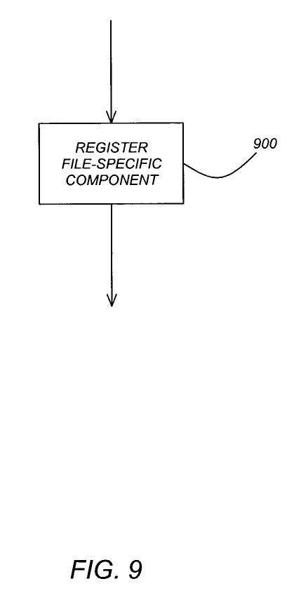

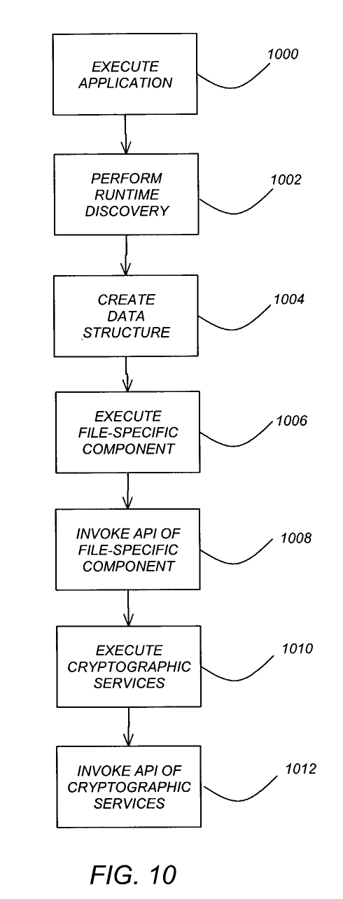

FIGS. 9 and 10 are flowcharts that illustrate the logic of the client software 108 according to the preferred embodiment of the present invention. Specifically, these flowcharts represent the execution of the Digital Signature Extension in a computer system, in order to provide a secure environment where digital signatures associated with the electronic documents can be verified. Those skilled in the art will recognize that this logic is provided for illustrative purposes only and that different logic may be used to accomplish the same results.

Referring to FIG. 9, Block 900 represents the client software 108 registering a file-specific component 202 with the digital signature extension as a “plug-in.” In this Block, the file-specific component 202 is registered as providing support for the electronic documents stored in the particular file format.

Referring to FIG. 10, Block 1000 represents the client software 108 executing one or more applications 200 in order to implement logic for accessing the documents 112 and for interfacing to the file-specific components 202, so that the file-specific components 202 can authenticate the digital signatures.

Block 1002 represents the application 200 performing runtime discovery of which file-specific component 202 provides support for the electronic documents 112 stored in the particular file format.

Block 1004 represents the application 200 creating a data structure to transport digital certificate-related and digital signature-related information between the file-specific components 202 and the cryptographic services 204.

Block 1006 represents the client software 108 executing one or more file-specific components 202 in order to authenticate the digital signatures associated with the electronic documents 112, wherein the electronic documents are stored in a particular file format, and in order to interface to the cryptographic services 204, so that the cryptographic operations can be performed on the digital signatures.

In this Block, the file-specific component 202 that is executed (i.e., instantiated) is the one found during the runtime discovery performed in Block 1002. Also, in this Block, the file-specific components 202 determine which portions of the particular file format are used to compute the digital signature. Finally, in this Block, the file-specific components 202 determine a location within the particular file format where the digital signature is stored.

Block 1008 represents the application 200 invoking various portions of an application programming interface of the file-specific component 202. Specifically, in this Block, one or more methods may be invoked by the application 200, wherein the methods are selected from a group of methods comprising: a method that determines if the electronic document is signed with the digital signature; a method that signs the electronic document with the digital signature; a method that validates the digital signature on the electronic document; and a method that extracts the digital signature from the electronic document.

Block 1010 represents the client software 108 executing the core cryptographic services 204 in order to perform cryptographic operations on the digital signatures associated with the electronic documents 112.

Block 1012 represents the file-specific components 202 invoking various portions of an application programming interface of the core cryptographic services 204. Specifically, in this Block, one or more methods may be invoked by the file-specific component 202, wherein the methods are selected from a group of methods comprising: a method that enumerates one or more digital certificates; a method that verifies the digital certificate; a method that computes the digital signature using the digital certificate; a method that verifies the digital signature; and a method that extracts data from the digital signature.

12 Conclusion

This concludes the description of the preferred embodiment of the invention. The following describes some alternative embodiments for accomplishing the present invention. For example, any type of computer or network configuration, such as a mainframe, minicomputer, personal computer, local area network, intranet or internet. Moreover, any type of application may utilize the invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for securing electronic documents comprising:
(a) a computer system; and
(b) a digital signature extension, executed by the computer system, for providing a secure environment where digital signatures associated with the electronic documents can be verified, wherein the digital signature extension comprises:
(1) cryptographic services for performing cryptographic operations on the digital signatures associated with the electronic documents;
(2) one or more file-specific components for authenticating the digital signatures associated with the electronic documents, wherein the electronic documents are stored in a particular file format, and for interfacing to the cryptographic services, so that the cryptographic operations can be performed on the digital signatures; and
(3) one or more applications for implementing logic for accessing the documents and for interfacing to the file-specific components, so that the file-specific components can authenticate the digital signatures.

2. The apparatus of claim 1, wherein the file-specific component is a “plug-in” registered with the digital signature extension as providing support for the electronic documents stored in the particular file format.

3. The apparatus of claim 2, wherein the digital signature extension includes runtime discovery by the application of which file-specific component provides support for the electronic documents stored in the particular file format.

4. The apparatus of claim 1, wherein the file-specific components include means for determining which portions of the particular file format are used to compute the digital signature.

5. The apparatus of claim 1, wherein the file-specific components include means for determining a location within the particular file format where the digital signature is stored.

6. The apparatus of claim 1, wherein the file-specific components include an application programming interface that includes one or more methods selected from a group of methods comprising:
a method that determines if the electronic document is signed with the digital signature;
a method that signs the electronic document with the digital signature;
a method that validates the digital signature on the electronic document; and
a method that extracts the digital signature from the electronic document.

7. The apparatus of claim 1, wherein the cryptographic services include an application programming interface that includes one or more methods selected from a group of methods comprising:
a method that enumerates one or more digital certificates;
a method that verifies the digital certificate;
a method that computes the digital signature using the digital certificate;
a method that verifies the digital signature; and
a method that extracts data from the digital signature.

8. The apparatus of claim 1, wherein the digital signature extension includes a data structure to transport digital certificate-related and digital signature-related information between the file-specific components and the cryptographic services.

9. A computer-implemented method for securing electronic documents, comprising:
(a) executing a digital signature extension in a computer system, in order to provide a secure environment where digital signatures associated with the electronic documents can be verified, wherein the executing step comprises:
(1) executing cryptographic services in order to perform cryptographic operations on the digital signatures associated with the electronic documents;
(2) executing one or more file-specific components in order to authenticate the digital signatures associated with the electronic documents, wherein the electronic documents are stored in a particular file format, and in order to interface to the cryptographic services, so that the cryptographic operations can be performed on the digital signatures; and
(3) executing one or more applications in order to implement logic for accessing the documents and for interfacing to the file-specific components, so that the file-specific components can authenticate the digital signatures.

10. The method of claim 9, wherein the file-specific component is a “plug-in” registered with the digital signature extension as providing support for the electronic documents stored in the particular file format.

11. The method of claim 10, wherein the step of executing the digital signature extension includes performing runtime discovery by the application of which file-specific component provides support for the electronic documents stored in the particular file format.

12. The method of claim 9, wherein the step of executing the file-specific components include determining which portions of the particular file format are used to compute the digital signature.

13. The method of claim 9, wherein the step of executing the file-specific components include determining a location within the particular file format where the digital signature is stored.

14. The method of claim 9, wherein the step of executing the file-specific components include an application programming interface that includes one or more methods selected from a group of methods comprising:
a method that determines if the electronic document is signed with the digital signature;
a method that signs the electronic document with the digital signature;
a method that validates the digital signature on the electronic document; and
a method that extracts the digital signature from the electronic document.

15. The method of claim 9, wherein the step of executing the cryptographic services include an application programming interface that includes one or more methods selected from a group of methods comprising:
a method that enumerates one or more digital certificates;
a method that verifies the digital certificate;
a method that computes the digital signature using the digital certificate;
a method that verifies the digital signature; and
a method that extracts data from the digital signature.

16. The method of claim 9, wherein the digital signature extension includes a data structure to transport digital certificate-related and digital signature-related information between the file-specific components and the cryptographic services.

17. A computer-implemented method for securing electronic documents, comprising:
(a) executing a digital signature extension in a computer system, in order to provide a secure environment where digital signatures associated with the electronic documents can be verified, wherein the executing step comprises:
(1) executing cryptographic services in order to perform cryptographic operations on the digital signatures associated with the electronic documents;
(2) executing one or more file-specific components in order to authenticate the digital signatures associated with the electronic documents, wherein the electronic documents are stored in a particular file format, and in order to interface to the cryptographic services, so that the cryptographic operations can be performed on the digital signatures; and
(3) executing one or more applications in order to implement logic for accessing the documents and for interfacing to the file-specific components, so that the file-specific components can authenticate the digital signatures.

18. The article of manufacture of claim 17, wherein the file-specific component is a “plug-in” registered with the digital signature extension as providing support for the electronic documents stored in the particular file format.

19. The article of manufacture of claim 18, wherein the step of executing the digital signature extension includes performing runtime discovery by the application of which file-specific component provides support for the electronic documents stored in the particular file format.

20. The article of manufacture of claim 17, wherein the step of executing the file-specific components include determining which portions of the particular file format are used to compute the digital signature.

21. The article of manufacture of claim 17, wherein the step of executing the file-specific components include determining a location within the particular file format where the digital signature is stored.

22. The article of manufacture of claim 17, wherein the step of executing the file-specific components include an application programming interface that includes one or more methods selected from a group of methods comprising:
a method that determines if the electronic document is signed with the digital signature;
a method that signs the electronic document with the digital signature;
a method that validates the digital signature on the electronic document; and
a method that extracts the digital signature from the electronic document.

23. The article of manufacture of claim 17, wherein the step of executing the cryptographic services include an application programming interface that includes one or more methods selected from a group of methods comprising:
a method that enumerates one or more digital certificates;
a method that verifies the digital certificate;
a method that computes the digital signature using the digital certificate;
a method that verifies the digital signature; and
a method that extracts data from the digital signature.

24. The article of manufacture of claim 17, wherein the digital signature extension includes a data structure to transport digital certificate-related and digital signature-related information between the file-specific components and the cryptographic services.
